(19) United States
(12) Patent Application Publication
(10) Pub. No.: US 2006/0098622 A1
(43) Pub. Date: May 11, 2006

(54) Architecture for a multi-media session controlled network

(75) Inventors: Su-Yuan Chang, Hsinchu (TW); Yin-Ju Chen, Hsinchu (TW)

Correspondence Address: ROSENBERG, KLEIN & LEE, 3458 ELLICOTT CENTER DRIVE-SUITE 101, ELLICOTT CITY, MD, 21043, US

(73) Assignee: Vicotel, Inc.

(21) Appl. No.: 10/982,436

(22) Filed: Nov. 5, 2004

(51) Int. Cl. H04L 12/66

(52) U.S. Cl. 370/352

(57) ABSTRACT

A method and system for a communication network architecture for passing multi-media data streams between two heterogeneous IP (Internet Protocol) networks, where the networks include a plurality of firewalls and NAT (Network Address Translation) devices. The architecture can include: (a) a session control server (b) a logger service to capture and to digitally store communication streams; (c) a network client service to initiate communication requests; (d) a network client service to receive communication requests; and (e) an administration service to control other network services and to monitor and log the communication quality and to generate communication traffic reports. The session control server can include: (f) a NAT device and firewall device traversal service; (g) a communication encryption service; (h) a bandwidth control service; (i) a quality monitoring service; (j) a proxy server ; (k) a registrar server; and any defined services in the architecture.

### BACKGROUND OF THE INVENTION

1. Field of the Invention

The invention relates to a network architecture, especially to an architecture for delivering media streams between NAT (Network Address Translation) and FW (Firewall) devices enable networks.

2. Description of the Prior Art

Normally, the media communications, including signaling streams and media streams, are carried out in the H.323 or Session Initiation Protocol. Those protocols allow the media client to enclose its addressing information. The signaling message is routed by the gatekeeper or proxy server to the target client. The target client looks into the message to know the first party address, and opens a media connection between those two parties.

However, a client may exist behind a NAT device, and the IP information for this particular client could be translated by NAT. The enclosed address information in the signaling message could be different from the real address. The target client may not be able to open the correct media connection to the first client.

Similarly, the first client may exist behind a firewall device, which usually rejects the direct connections between intranet and internet. The media connections from each side may also be rejected by a firewall.

Further more, this kind of end to end media connections qualities cannot be controlled, monitored, or recorded. This consequently made media traffics hard to manage, trace, or recover. The network architecture should be able to provide a platform for no boundary communication and an administration mechanism to improve its service.

### SUMMARY OF THE INVENTION

According to the invention, it is provided a method and a system for a communication network architecture for passing multi-media data streams between two heterogeneous IP (Internet Protocol) networks, where the networks include a plurality of firewalls and NAT (Network Address Translation) devices. The architecture can include: a session control server; a logger service to capture and to digitally store communication streams; a network client service to initiate communication request; a network client service to receive communication requests; and an administration service to control other network services and to monitor and log the communication quality and to generate communication traffic reports. The session control server can include: a NAT device and firewall device traversal service; a communication encryption service; a bandwidth control service; a quality monitoring service; a proxy server; a registrar server; and any defined services in the architecture.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is an example of a session controlled network for a network client service exchanging multi-media information with another network client service.

FIG. 2 is a schematic diagram of the components of the session controller and its interfaces with the components of the session controlled network.

FIG. 3 is a flow diagram of the sequence of events which occur in one embodiment when a network client service behind NAT or firewall devices sends its signaling messages to resolve its addressing issues.

FIG. 4 is a flow diagram of the sequence of events which occur in one embodiment when a network client service behind NAT or firewall devices exchanges its signaling messages with another network client service.

FIG. 5 is a flow diagram of the sequence of events which occur in one embodiment when a network client service behind NAT or firewall devices exchanges its media messages with another network client service.

### DETAILED DESCRIPTION OF THE PREFERRED EMBODIMENTS

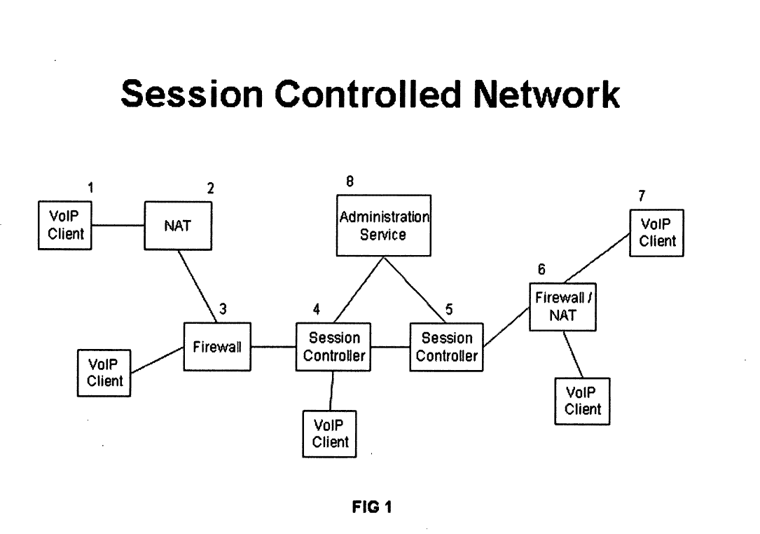

The session controlled network is built up with a plurality of session control servers, a plurality of client service, and an administration service. This network can relay media streams between networks comprising NAT or firewall devices, as shown in FIG. 1. The client 1, behind NAT 2 or firewall 3 devices initializes a signaling communication request. The session control server 4 relays the request and brings in the target client connection by translating source address with the session server address, and brings in the first client connection. The typical sequence of events is: (1-8)

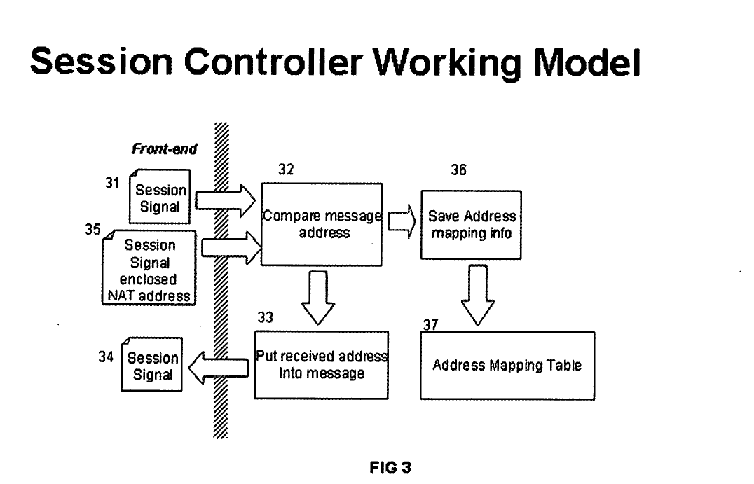

1. The first client service detects the address of the first available session control server, and sends the first signaling request 31 to the session control server, as shown in FIG. 3. The client service will be redirected to the backup session control server if the connected session control server is not able to provide services due to system failures or running out of system resources.

2. The session control server can compare the sender address with the address 32 within the signaling message to determine the client side NAT device, and reply with the received address information 33 back to the first client if client side NAT device is enable.

3. The first client receives the response message 34, encloses new address information into the signaling message 35, and sends it to the session control server, which will save address information 36 in address mapping table 37.

4. The session control server can send registration information for the first client to any media registration servers if the address translation is resolved, and the session control server can digitally store the client side NAT and firewall information.

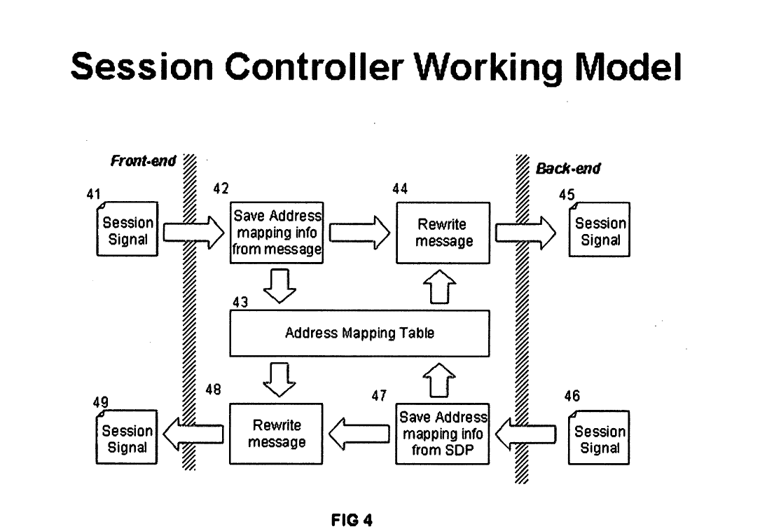

5. In FIG. 4, the first client communicates with another registered client by sending another signaling request message 41. The session control server saves the media information address 42 into the address table 43, rewrites the address information 44, and reroutes the signaling message 45 to the second client.

6. The second client can accept the communication request to establish a signaling connection, and reply the signal message 46 in the same way.

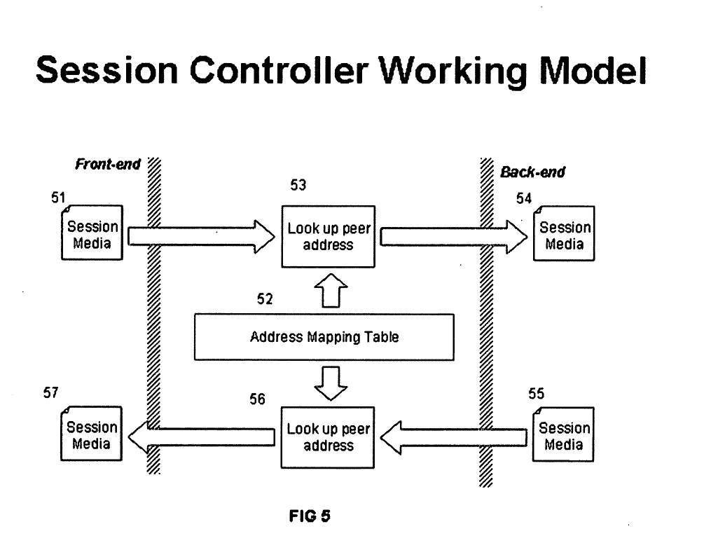

7. As shown in FIG. 5, once the signaling connection establishing, the second client can send media message 55 back to session controller. The session controller can lookup peer address 56 from the address table 52, and reroute the media message 57 back to the first client. The first client can sends media message 51 to the second client using the same way. Therefore, the media communications for both parties are connected.

8. The NAT device and firewall device traversal service in the service control service is used to manage media communication flows and sessions, and this service can digitally store the IP mapping information, including IP information for both network client services involving in the same media communication. The IP mapping information can be used later by system administrator to do network trouble shooting.

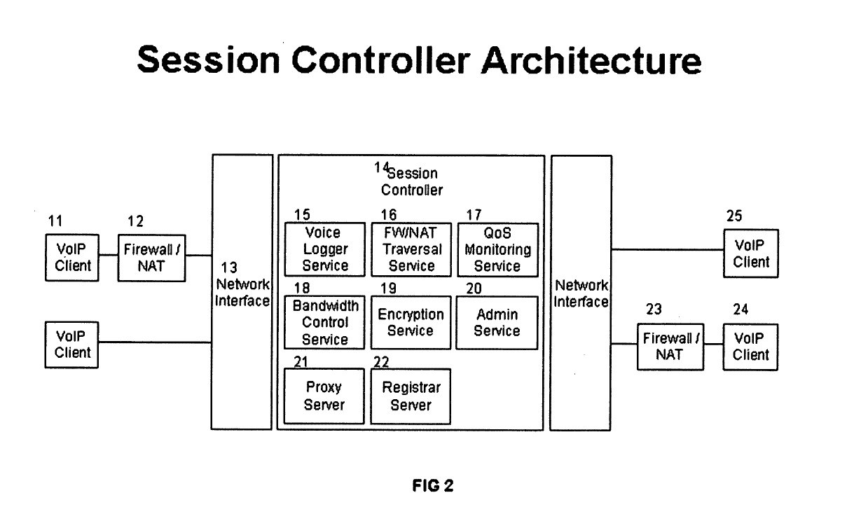

According to our invention as shown in FIG. 2, the NAT device and firewall device traversal service 16 in the session control service are supported by four functional layer services. A logger service 15 is introduced to capture and digitally record the media streams; a encryption 19 service is used to encrypt and decrypt media content to ensure the security of communication; a bandwidth management service 18 is used to assist other network device to control bandwidth; a quality monitoring service 19 is used to log QoS (quality of service) related information.

Furthermore, the logger service running on the session control server can be triggered or invoked while the media stream is connected. The logger service can digitally store and retrieve media streams. The typical sequence of events is: (1-4)

1. The session control server, managing the connection flow control, can invoke the logger service to verify the recording policy against the media stream profile. Once the policy is matched, the logger service starts to digitally stores the raw data of the matched media stream

2. The session control server can invoke the retrieval function of the logger service to retrieve data once the recording process is finished. The logger service verifies the query specification with saved records, and only the matched records will be returned.

3. The logger service can convert those matched records from raw data, which may be encoded or encrypted earlier, to media streams in a common playable format by using proper supporting services.

4. The logger service can restore original multi-media communication by mixing two or more media streams, which belong to the same communication, into a single media stream in a common playable format.

The communication encryption service can also be invoked by the session control server or the network client service to encrypt the data in media streams. For example, a network client service and a session control server are in a trusted network. The network client can send media data to the session control server. The session control server can encrypt the media data, and send the encrypted media data to another network client service, which may not belong to the same trusted network. The second network service can decrypt the media data. Hence, the communication security between any network client services can be ensured using this mechanism.

The bandwidth management service labels the priorities of the media packages in TOS (Type of Service) format based on defined rules, which contain the weight measurement of the media content, the media format, and the sender profile information. The network devices, such as routers or switches, can facilitate those TOS information to allocate proper network resource for each media package.

The quality monitoring service is used to record the jitter level and package lost rate of the communication media stream. For example, a network client service sends media streams to another network client service through a session control server. The receiver client service calculates the jitter level and package lost rate based received media data, and sends this information back to the session control server and original sender client service.

The session control server provides codec translation and media signaling protocol translation functionality. The typical sequence of events is: (1-4)

1. The session control server receives one type of signaling protocols; it automatically detects the signaling protocol of the destination client.

2. The session control server invokes the proper protocol translation service if the source signaling protocol is different from the destination protocol. The translation service translates the signaling message. The session control server sends the translated signaling message to the destination clients.

3. Similarly, the session control server receives one type of media codec; it automatically detects the media codec of the destination client.

4. The session control server invokes the proper codec translation service if the source media codec is different from the target media codec. The codec translation service converts the media codec. The session control server sends the converted media stream to the destination client.

In FIG. 1, the administration service 8 provides a unified administration interface for administrators to access and manage one or more session control servers. The administration processes of the administration service can be divided into three categories: processes for retrieving recorded communication information from one or more session control servers; processes for generating reports and graphics based on retrieving information; and processes for updating session control servers' profile and configuration.

The main processes for retrieving recorded communication information from session control servers consist of retrieving client side NAT information, retrieving client service IP mapping information, retrieving network resource usage of the session control servers, and retrieving the communication routing information.

The administration service can invoke certain processes to generating reports and graphics. First of all, the administration service collects recorded communication information from session control servers, and stores this information into a database server. An administrator facilitates its user interface to construct a query specification, and the query specification is passed to a query service to do the further parsing. The policy service uses this parsed result to match conditions and retrieve corresponding data from the database server. The graphic service uses retrieved data to generate graphic diagrams.

In addition, each session control server provides retrieval interfaces and a report service to export recorded communication information into files. The administration service can directly access the retrieval interfaces in session control servers or import the exported files to collect recorded communication information.

Each session control server also provides configuration interfaces. The administration service can access these interfaces to update session control servers' configurations. The administration service can load predefined configuration template files to perform a group setup for session control servers through the same interfaces.

In typical embodiments of operation, the administration service can be implemented in any one of session control servers or in an independent server, and the network client services can be implemented in

While the invention has been described with respect to certain preferred embodiments and exemplifications, this is not intended to limit the scope of the invention thereby, but sole by the claim appended hereto.

1. A method for passing multi-media data stream between two heterogeneous IP (Internet Protocol) networks where the networks include a plurality of firewalls and NAT (Network Address Translation) devices. The architecture comprises:
(a) a session control server (b) a logger service to capture and to digitally store communication streams; (c) a network client service to initiate communication requests; (d) a network client service to receive communication requests; and (e) an administration service to control other network services and to monitor and log the communication quality and to generate communication traffic reports. The session control server comprises: (f) a NAT device and firewall device traversal service; (g) a communication encryption service; (h) a bandwidth control service; (i) a quality monitoring service; (j) a proxy server; (k) a registrar server; and any defined services in the architecture.

2. The method of claim 1 wherein the network client for accessing the session control server establishes a communication connection combining a signaling protocol flow and a media stream, and connects a plurality of destinations through a plurality of session control servers comprising:
(a) means for detecting NAT or FW devices between network clients and session control server.
(b) means for receive and send multi-media data streams through NAT or FW devices between clients and session control server.

3. The method of claim 1 wherein the session control server can be accessed by a network client service, a session control server, or an administration service.

4. The method of claim 1 wherein the session control server for managing the communication session information amount a plurality of network clients behind a plurality of firewalls and NAT devices comprising:
means for detecting NAT or FW devices between network clients and session control server.
means for assist network clients receive and send multi-media data streams through NAT or FW devices between clients and session control server.
means for receiving signal and media address information for network clients or client side NAT (Network Address Translation).
means for converting the signal and media address information of the sender for the inbound request message to the address information based on the session control server for the outbound message.
means for converting the signal and media address information of the receiver for the inbound response message to the IP information based on the session control server for the outbound message.
means for creating and managing the address mapping information between the network sender service and the receiver service.
means for converting the address information of multi-media packages between the sender and the receiver based on the created address mapping information.

5. The method of claim 2 wherein the initialization of accessing a session control server includes the capability of automatically detecting the first available session control server.

6. The method of claim 1 wherein the communication information could be encrypted or decrypted by a communication encryption service to ensure the communication security.

7. The method of claim 1 wherein transmitting the communication media stream is managed by a bandwidth control service based on the priority of the media data package.

8. The method of claim 7 wherein the bandwidth control service labels the priority for each transmitted media package based on the media format or the content of the data.

9. The method of claim 1 wherein the session server invokes the quality monitoring service to monitor the jitter level and the package lost rate of the communication media stream and allocates a record resource to store all relevant information.

10. The method of claim 1 wherein the logger service can be resident on the session control server, capture the media streams passing through the session control server, and digitally store them into any devices.

11. The method of claim 2 wherein translating the incoming signaling protocol into the destination signaling protocol comprising:
means for receiving one type of signaling protocols request;
means for invoking the converting process if the incoming signaling protocol is different from the destination signaling protocol;
means for sending the target signaling protocol.

12. The method of claim 2 wherein translating the incoming media codec into the destination media codec comprising:
means for receiving one type of media codec;
means for invoking the translating process if the incoming media codec is different from the destination media codec;
means for decoding the incoming media stream and decoding to the target media codec.
means for sending the target media codec.

13. The method of claim 4 wherein the IP mapping information, NAT information, and communication detail reports can be stored in any device.

14. The method of claim 13 wherein the IP mapping information includes the sender IP information and the receiver IP information.

15. The method of claim 13 wherein the NAT information includes the sender side NAT information and the receiver side NAT information.

16. The method of claim 1 wherein the communication data stream can be redirected to an appropriate session server while the current session server is not able to provide services.

17. The method of claim 1 wherein the administration service can access and manage a plurality of session control servers.

18. The method of claim 1 wherein the administration service can be resident on the session control server or can be resident on an independence server.

19. The method of claim 1 wherein the administration service can collect information from a plurality of session control servers by accessing directly to their retrieval interfaces or reading the exported files generated by their reporting services.

20. The method of claim 1 wherein the administration service can configure the profiles of a plurality of session control servers by loading one or more template files.

21. The method of claim 20 wherein the profile information includes addressing of session control servers and an administration service.

22. The method of claim 1 wherein the administration service interacts with a session control server to retrieve IP and NAT information for all communications passing through this session control server.

23. The method of claim 1 wherein the administration service interacts with a session control server to retrieve network resource usage for all communications passing through this session control server.

24. The method of claim 1 wherein the administration service interacts with a plurality of session control server to identify the routing and quality degrading information for the particular communication.

25. The method of claim 1 wherein the administration service can generates table or graphic reports based on the collected information.

26. The method of claim 25 wherein the collected information can be further sorted or filtered by a query service or a policy service.

27. The method of claim 1 wherein the network client service can be resident on a hardware device, a web browser, an application, or any objects combining of any of those three components.
